(19) United States
(12) Patent Application Publication
(10) Pub. No.: US 2015/0178722 A1
(43) Pub. Date: Jun. 25, 2015

(54) TEMPORARY PASSCODE GENERATION FOR CREDIT CARD TRANSACTIONS

(71) Applicant: International Business Machines Corporation, Armonk, NY (US)

(72) Inventors: Joshua A. Alger, Raleigh, NC (US); Jeffrey R. Hoy, Southern Pines, NC (US); Barry J. Pellas, Raleigh, NC (US); David M. Stecher, Seattle, WA (US)

(73) Assignee: International Business Machines Corporation, Armonk, NY (US)

(21) Appl. No.: 14/135,939

(22) Filed: Dec. 20, 2013

(51) Int. Cl. G06Q 20/38; G06Q 20/20; G06Q 20/34

(52) U.S. Cl. CPC G06Q 20/385; G06Q 20/34; G06Q 20/20

(57) ABSTRACT

Embodiments of the present invention disclose a method, computer program product, and system for verifying the identity of a card user. A computer sends one or more temporary passcodes to a user device. The computer sends a prompt to a point of sale device, wherein the prompt requests a predefined, identifying input. The computer receives the temporary passcode, the computer verifies that the received temporary passcode is substantially similar to at least one of the one or more passcodes sent to the user device.

### FIELD OF THE INVENTION

The present invention relates generally to the field of credit card transactions and more particularly to passcode generation.

### BACKGROUND OF THE INVENTION

Credit card transactions may require more than possession of the credit card information (e.g., credit card number, authentication code, and expiration date) in order to verify the transaction and authorize a purchase. In addition to the credit card information, vendors, credit card companies, and banks can request additional information that is not included on the credit card in order to verify that the person attempting to use the credit card information to make a purchase is an authorized user. In some scenarios, a credit card user may have to enter a personal identification number (PIN) or the zip code associated with the billing address of the credit card. “Smart cards” include on-board computer chips that can include encryption information in order to make intercepting credit card information during a transaction more difficult. Other credit cards include a system for biometric verification, such as fingerprint scanners, to verify that the user of a card is an authorized user.

### SUMMARY

Embodiments of the present invention disclose a method, computer program product, and system for verifying the identity of a card user. A computer sends one or more temporary passcodes to a user device. The computer sends a prompt to a point of sale device, wherein the prompt requests a predefined, identifying input. The computer receives the temporary passcode, the computer verifies that the received temporary passcode is substantially similar to at least one of the one or more passcodes sent to the user device.

### BRIEF DESCRIPTION OF THE SEVERAL VIEWS OF THE DRAWINGS

FIG. 1 is a functional block diagram illustrating a credit card transaction environment, in accordance with an embodiment of the present invention.

FIG. 2 is a front view of a credit card, in accordance with an embodiment of the present invention.

FIG. 3 is a back view of a credit card, in accordance with an embodiment of the present invention.

FIG. 4 is a functional block diagram showing the internal components of a credit card in accordance with an embodiment of the present invention.

FIG. 5 is a flowchart depicting operational processes of a temporary passcode program, in accordance with an embodiment of the present invention.

FIG. 6 depicts a series of communications between a credit card holder and a credit processing system, in accordance with an embodiment of the present invention.

FIG. 7 depicts a block diagram of the components of the computer system executing the temporary passcode program, in accordance with an embodiment of the present invention.

### DETAILED DESCRIPTION

Embodiments of the present invention recognize that credit card security and the prevention of credit card fraud are common concerns of many credit card holders, commercial vendors, and credit card companies. The present disclosure is directed to the reduction of credit card fraud. The present disclosure includes a credit card designed for receiving communications via a communications network and a biometric verification mechanism as well as a method of using the credit card comprising the use of limited use, temporary personal identification numbers that are communicated to the card holder over the communications network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk®, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

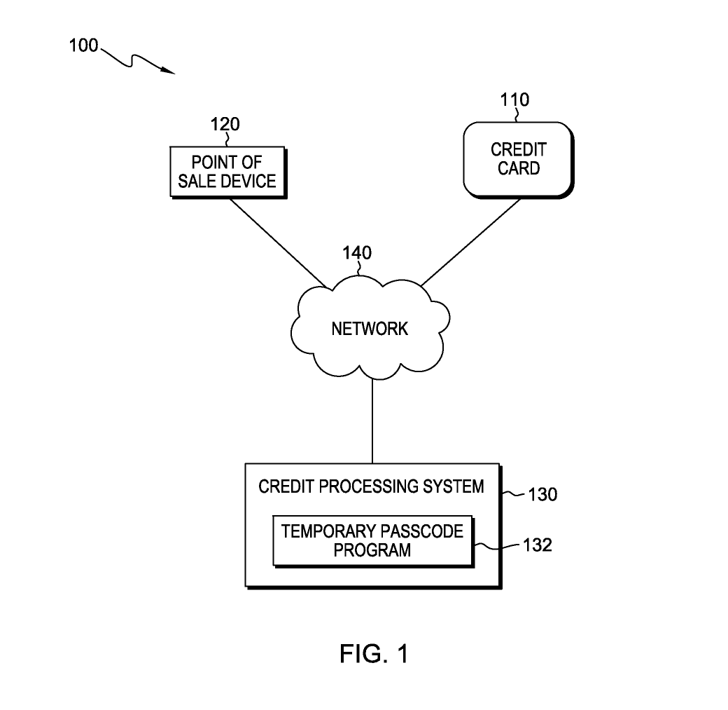

The present invention will now be described in detail with reference to the Figures. FIG. 1 is a functional block diagram illustrating a credit card transaction environment, generally designated 100, in accordance with an embodiment of the present invention. Credit card transaction environment includes credit card 110, point of sale device 120, and credit processing system 130, all connected via network 140.

Credit card 110 is an enhanced smart card having the capability to communicate via network 140 with credit processing system 130 and point of sale device 120. Credit card 110 includes attributes commonly used in the art to initiate credit card transactions such as a 16-digit credit card number, a three or four digit authorization code, a magnetic stripe, the card holder's name, and the expiration date of the card. Additionally, credit card 110 includes imbedded programmable logic for communicating with point of sale device 120 and credit processing system 130 via network 140.

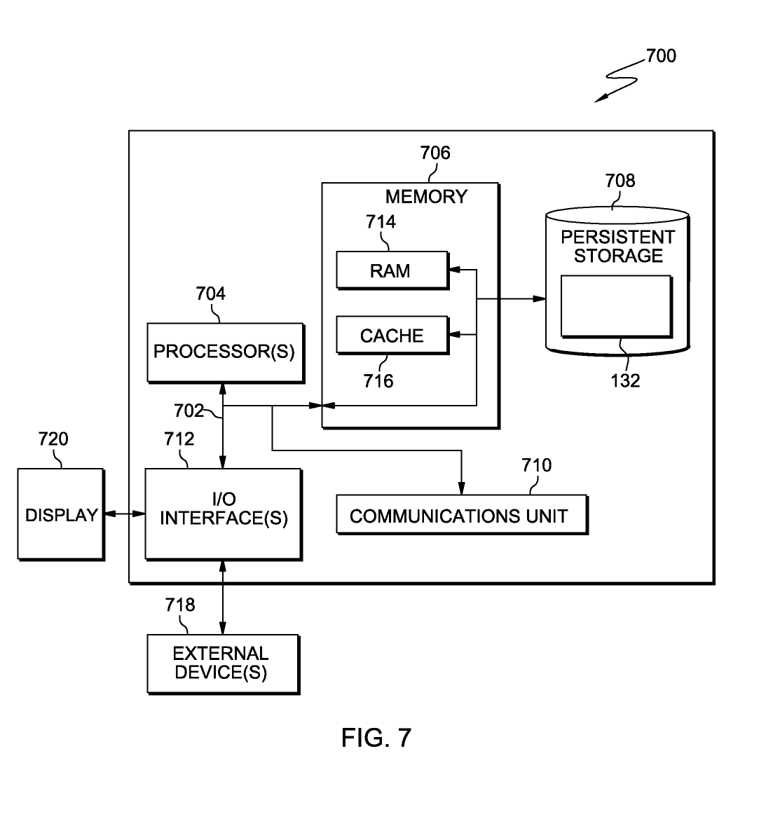

Point of sale device 120 is a computing device capable of receiving credit card information from credit card 110 or a card holder with access to the information on credit card 110. In various embodiments of the present invention, point of sale device 110 can be a server, a laptop computer, a tablet computer, a netbook computer, a personal computer (PC), a desktop computer, a personal digital assistant (PDA), a smart phone, or any programmable electronic device capable of communicating with credit card 110 and credit processing system 130 via network 140. In one embodiment, point of sale device includes a magnetic strip reader for receiving credit card information from credit card 110 via a magnetic strip located on credit card 110. Point of sale device 120 may include internal and external hardware components, as depicted and described in further detail with respect to FIG. 7.

Credit processing system 130 is a computing system that receives credit card information from the point of sale device and verifies the information prior to authorizing the purchase. In various embodiments of the present invention, credit processing system 130 performs the verification of the credit information by executing temporary passcode program 132 and communicating with credit card 110 via network 140. In various embodiments of the present invention, point of sale device 110 can be a server, a laptop computer, a tablet computer, a netbook computer, a personal computer (PC), a desktop computer, a personal digital assistant (PDA), a smart phone, or any programmable electronic device capable of communicating with credit card 110 and point of sale device 120 via network 140. In another embodiment, credit processing system 130 represents a computing system utilizing clustered computers and components to act as a single pool of seamless resources. Credit processing system 130 may include internal and external hardware components, as depicted and described in further detail with respect to FIG. 7. Credit processing system 130 includes temporary passcode program 132. Temporary passcode program 132 receives the credit information transmitted by point of sale device 120 and transmits a temporary PIN to credit card 110, over network 140, for use in a credit card transaction.

Credit card 110, point of sale device 120, and credit processing system 130 communicate via network 140. Network 140 can be, for example, a local area network (LAN), a wide area network (WAN), such as the internet, or a combination of the two, and may include wired, wireless, fiber optic, or any other connection known in the art. In general, network 140 can be any combination of connections and protocols that will support communications between credit card 110, point of sale device 120, and credit processing system 130.

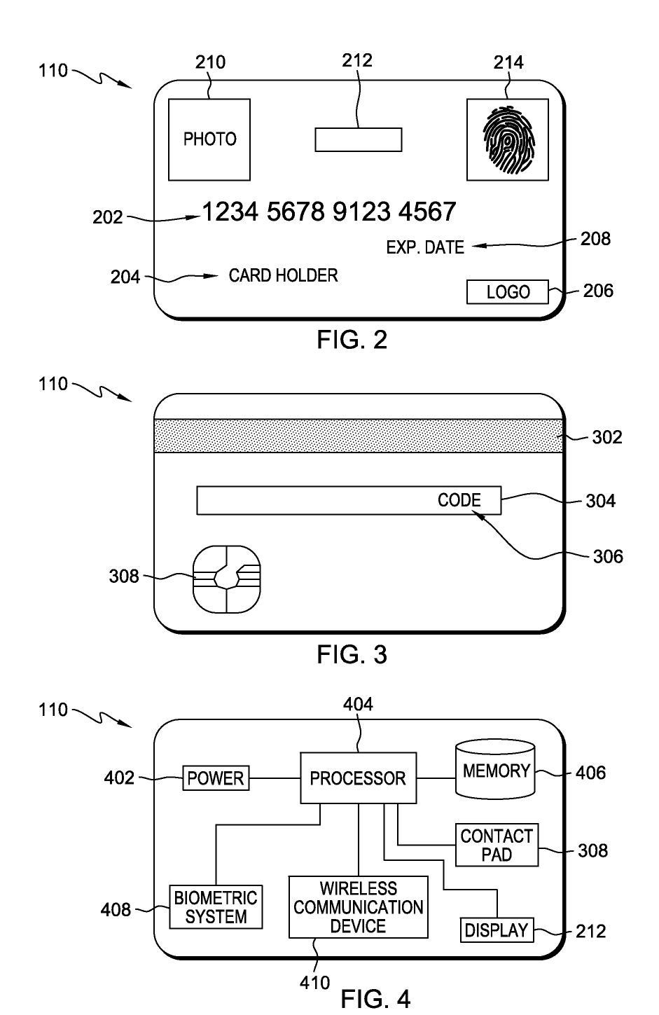

FIG. 2 is a front view of a credit card, in accordance with an embodiment of the present invention.

In one embodiment, credit card 110 is a plastic card having the shape and size of a conventional credit card. For example, credit card 110 is approximately 3⅜ inches×2⅛ inches×⅛ inch. Credit card 110 includes card number 202. In one embodiment, card number 202 is raised compared to the front surface of credit card 110. In another embodiment, card number 202 is a conventional, 15-digit or 16-digit credit card number that corresponds to a credit account associated with the card. In another embodiment, credit card 110 has printed thereon card holder name 204, credit company logo 206, card expiration date 208, and/or cardholder photograph 210.

In one embodiment, credit card 110 includes biometric scanner 214. Biometric scanner 214 includes a biometric sensor capable of reading biometric information, such as a finger print. In one embodiment, biometric scanner 214 verifies that the person in possession of credit card 110 has authorization to use credit card 110 in transactions. In another embodiment, biometric scanner 214 verifies the identity of the user in possession of credit card 110 prior to displaying a temporary PIN number on credit card 110 for use in a credit card transaction.

Credit card 110 includes display 212. Display 212 can be any type of screen capable of visually displaying a series of letters and/or numbers such as a liquid-crystal display (LCD), a light emitting diode (LED) display, or an electronic paper display. In one embodiment, display 212 displays a temporary PIN for use in a limited number of credit card transactions.

FIG. 3 is a back view of a credit card, in accordance with an embodiment of the present invention.

In one embodiment, credit card 110 includes magnetic stripe 302. Magnetic stripe 302 can be any standard magnetic stripe such as a high-coercivity stripe or a low-coercivity stripe and made of any suitable magnetic material such as iron particles on a magnetic material. Information stored in the magnetic strip can include any credit related information such as card number 202, card holder name 204, and expiration date 208 of credit card 110. In come embodiment, credit card 110 includes another suitable medium of information storage such as flash memory. Credit card 110 includes signature box 304. Signature box 304 is a standard credit card feature in which the card holder signs credit card 110 in order to compare to signatures at a later date to verify that the person using the card is the authorized card holder. In one embodiment credit card 110 includes authentication code 306. Authentication code 306 is a three or four digit number used to verify that the user attempting to use credit card 110 is in possession of the card and not merely in possession of card number 202.

In one embodiment, credit card 110 includes contact pad 308. Contact pad 308 connects to programmable logic, such as an integrated circuit imbedded in credit card 110. Contact pad 308 enables credit card 110 to communicate with a smart card reader and can be used to supplement or substitute the information stored on magnetic stripe 302. In one embodiment, contact pad 308 supplies power to the circuit stored on credit card 110 and communicates via direct electrical contact with the smart card reader. In another embodiment, credit card 110 communicates with the smart card reader via radio frequency (RF). Credit Card 110 has a wire loop embedded inside that is used as an inductor to supply energy to the card and communicate with the smart card reader. When a user inserts credit card 110 into the card reader's RF field, an induced current occurs in the wire loop and credit card 110 uses this induced current as an energy source.

FIG. 4 is a functional block diagram showing the internal components of credit card 110, in accordance with an embodiment of the present invention.

In one embodiment, credit card 110 includes power source 402, processor 404, memory 406, biometric system 408, contact pad 308, display 212, and wireless communication device 410. In one embodiment, power source 402 is a battery that provides electrical power to each of the other components via the connection with processor 404. Processor 404 electrically connects to each of the other components. Processor 404 is a microprocessor that performs calculations, manages power distribution from power source 402, and manages communication between the components. For example, in one embodiment, processor 404 receives temporary passcode from wireless transmitter 410 and biometric information from biometric system 408, and based on the biometric information, determines whether or not to display the temporary passcode information on display 212. Credit card 110 includes biometric system 408. Biometric system 408 receives biometric inputs, such as fingerprint data, from biometric scanner 214 and determines whether the received biometric information is the same as previously stored reference biometric information. Memory 406 can be any on-board, physical memory such as random access memory (RAM).

In one embodiment, credit card 110 includes wireless communication device 410. Wireless communication device 410 has the ability to communicate wirelessly with other devices that have wireless communication capabilities, such as credit processing system 130. For example, wireless communication device 410 can be enable to communicate via 3G networks, 4G networks, IEEE 802.11x standard wireless local area network, or Bluetooth®. Embodiments using 3G or 4G cellular radio for communication include authorization to a cellular data network, such as network 140. Embodiments implementing IEEE 802.11x technology uses nearby Wi-Fi hotspots in order to communicate with other devices, such as credit processing system 130 over network 140. Embodiments enabled to use Bluetooth® technology include a nearby computer or mobile device, such as a cellular phone, that is also enabled with Bluetooth® technology and maintains its own, independent connection to network 140 for communicating with other devices such as credit processing system 130.

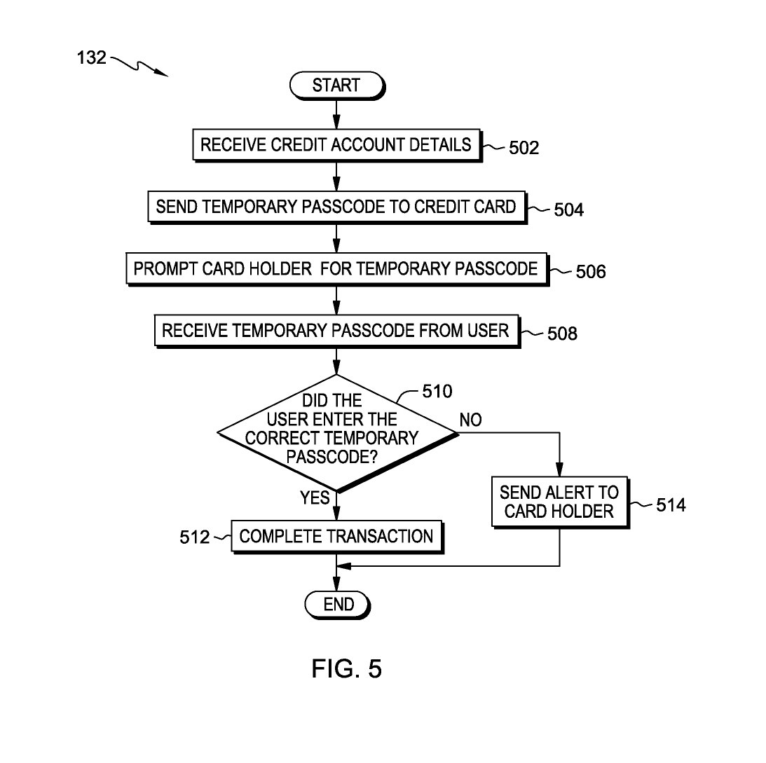

FIG. 5 is a flowchart depicting operational processes of a temporary passcode program, in accordance with an embodiment of the present invention.

Temporary passcode program 132 receives credit account information (process 502). In one embodiment, the card holder initiates a credit purchase by swiping magnetic stripe 302 at point of sale device 120. Point of sale device 120 communicates with credit processing system 130 via network 140. Point of sale device 120 transmits credit information, such as card number, cardholder name, and expiration date to credit processing system 130.

Temporary passcode program 132 sends a temporary passcode to credit card 110 (process 504). A temporary passcode is any passcode that has a limit on the usage of the code, such as a limited number of transactions for which the passcode is valid, a limited period of time during which the passcode may be used, or both. In one embodiment, temporary passcode program 132 instructs credit processing system 130 to communicate with credit card 110 via network 140. Credit card 110 receives the temporary passcode using wireless communication device 410. Credit card 110 displays the temporary passcode on display 212. In another embodiment, temporary passcode program 132 sends multiple temporary passcodes, which credit card 110 stores in memory 406. The multiple temporary passcodes can be used for future transactions in the event that credit card 110 does not have access to network 140 at the time of the transaction. In one embodiment, credit card 110 verifies that the card holder is authorized to make purchases using credit card 110 by verifying the card holder's identity prior to displaying the temporary passcode. For example, the card holder must scan his or her fingerprint using biometric scanner 214. Credit card 110 then compares the scan of the card holder's fingerprint with a reference fingerprint that was previously stored in memory 406. If the fingerprints match, then credit card 110 displays the temporary passcode. In another embodiment, the credit card user receives the temporary passcode on a smart phone connected to credit processing system 130 via network 140.

Temporary passcode program 132 prompts the card holder for the temporary passcode (process 506). In one embodiment, temporary pass code program 132 instructs credit processing system 130 to send a prompt via network 140 to point of sale device 120, requesting that the card holder manually input the temporary passcode into point of sale device 120. Point of sale device 120 communicates the temporary passcode to credit processing system 130 via network 140 for verification. Temporary passcode program 132 receives the temporary passcode from the user (process 508).

Temporary passcode program 132 determines whether the user entered the correct temporary passcode (decision process 510). In one embodiment, temporary passcode compares the temporary passcode received from the user in process 508 with the temporary passcode that temporary passcode 132 sent to credit card 110 in process 504. If temporary passcode program 132 determines that the user entered the correct passcode (decision block 510, yes branch), then temporary passcode program 132 instructs credit processing system 130 to complete the transaction in process 512. If temporary passcode program 132 determines that the user did not enter the correct temporary passcode (decision block 510, no branch), then temporary passcode program 132 instructs credit processing system 130 to send an alert to the card holder in process 514. In one embodiment, the alert is sent to point of sale device 120 and the card holder is prompted to re-enter the temporary passcode.

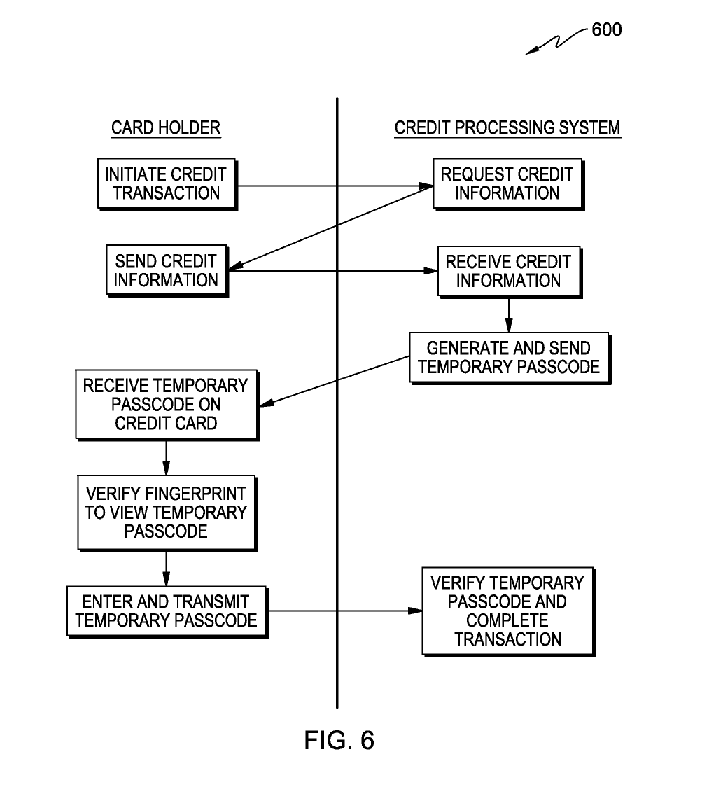

FIG. 6 depicts a series of communications, generally designated 600, between a credit card holder and a credit processing system, in accordance with an embodiment of the present invention.

In this embodiment, the card holder has access to both credit card 110 and to point of sale device 120. Therefore, communications between the card holder and credit processing system 130 may occur entirely through communications between credit processing system 130 and credit card 110, entirely through communications between point of sale device 120 and credit processing system 130, or through a combination of communications through both credit card 110 and point of sale device 120.

The card holder initiates a credit transaction by, for example, swiping credit card 110 through a magnetic stripe reader. Credit processing system 130 responds by requesting the credit information associated with the credit card. The card holder supplies the credit information by, for example, manually entering the credit information via a graphical user interface on point of sale device 120. Credit processing system 130 receives the credit information, generates a temporary passcode, and transmits the temporary passcode to the card holder. The card holder receives the temporary passcode on, for example, a wireless communication enabled credit card. The card holder verifies his or her fingerprint using a biometric scanner in order to view the temporary passcode on a display, such as display 212. The cardholder enters the temporary passcode on, for example, point of sale device 120 and transmits the temporary passcode to credit processing system 130. Credit processing system 130 receives the temporary passcode, verifies the passcode with the passcode sent to the card holder, and completes the credit transaction.

In another embodiment, temporary passcode program 132 sends one or more temporary passcodes to a user device, such as a smartphone, laptop, netbook, personal computer, personal digital assistant, tablet computer, wirelessly enabled credit card, or any electronic device capable of communicating with credit processing system 130 via network 140. In this embodiment, the user device receives the temporary passcode from credit processing system 130. In one embodiment, the user device also includes printed instructions informing the user to enter the temporary passcode in lieu of requested, predefined, identifying inputs such as zip code. Credit processing system 130 sends a prompt to point of sale device 120 for user input. The prompt may be a request for a commonly requested, predefined, identifying input, such as a zip code, to verify the user's identity. In this embodiment, temporary passcode program 132 receives the temporary passcode, entered in lieu of, for example, the user's zip code. Further examples of commonly requested, predefined, identifying inputs include security questions (e.g. mother's maiden name, high school mascot, name of first pet, etc.).

When temporary passcode program 132 receives the user input, then temporary passcode 132 compares the input with the temporary passcodes associated with that card user to determine if the user input matches one of the temporary passcodes associated with the user. If the user input is a temporary passcode associated with the card holder, then temporary passcode program 132 instructs credit processing system 130 to complete the transaction. If the user input does not match one of the temporary passcodes associated with the user, then temporary passcode program 132 instructs credit processing system 130 to terminate the transaction and send an alert to the user associated with the card (e.g. by email or text message) informing the user of potential fraud.

Alternatively, the user can configure temporary passcode program 132 to receive either a zip code or a temporary passcode associated with the user's account. In this embodiment, temporary passcode program 132 determines whether the received input is a temporary passcode that is associated with the user who entered the input. If the temporary passcode is associated with the user executing the transaction, then temporary passcode program 130 verifies the passcode and instructs credit processing system 130 to complete the transaction. If temporary passcode program 132 determines that the received input is not a temporary passcode associated with the user, then temporary passcode program 132 determines whether the user input matches the prompted field. For example, if the user input was placed into a field prompting for zip code, and the user input is not a temporary passcode, then temporary passcode program 132 determines whether the user input matches the user's zip code.

In this embodiment, if temporary passcode program 132 determines that the user input does not match either a temporary passcode associated with the user or the information requested in the prompt, then temporary passcode program 132 instructs credit processing system 130 to terminate the transaction and notifies the card holder of the failed transaction. If temporary passcode program 132 determines that the user input is not a temporary passcode associated with the user, but is a zip code associated with the user, then temporary passcode program 132 instructs credit processing system 130 to complete the transaction.

In one embodiment, temporary passcode program 132 can be a verification system independent of credit processing system 130. In this embodiment, temporary passcode program 132 represents an intermediary between point of sale device 120 and credit processing system 130. In this embodiment, temporary passcode program 132 can be stored on an independent server system, or any other computing device capable of communicating with point of sale device 120 and credit processing system 130 via network 140. In this embodiment, point of sale device 120 sends the credit verification information, including a temporary passcode entered by the card user. Temporary passcode program 132 intercepts the credit verification information and verifies that the temporary passcode entered by the user matches a temporary passcode associated with that user's account. In response to confirming that the temporary passcode submitted by the user matches a temporary passcode associated with the user's account, temporary passcode program 132 sends confirmation to credit processing system 130, which can be the banking institution's internal system. Credit processing system 130 verifies that the account has sufficient funds in the account associated with the user, and if the account does have sufficient funds, authorizes the transaction.

Alternatively, temporary passcode program can, after confirming that the received user submitted temporary passcode matches a temporary passcode associated with the user, temporary passcode program 132 substitutes the temporary passcode with the requested information prior to sending the credit information on to the banking institution. For example, temporary passcode program 132 confirms the temporary passcode submitted by the user in lieu of zip code. Temporary passcode then replaces the temporary passcode with the zip code of the user prior to sending the credit information to the banking institution. The banking institution then confirms the transaction. In this embodiment, temporary passcode program 132 can be implemented into existing credit transaction networks without modifying existing credit processing systems.

In another embodiment, temporary passcode program 132 is an integrated part of credit processing system 130. For example, temporary passcode program 132 can be part of the banking institution's internal credit card verification system. In this embodiment, the user initiates the transaction at the point of sale device and, when prompted for the predefined, identifying inputs (e.g., zip code) then the user inputs the temporary passcode. Credit processing system 130, such as a banking institution's internal servers verifies that the temporary passcode entered matches a temporary passcode associated with the card holder.

FIG. 7 depicts a block diagram of the respective components, generally designated 700, of point of sale device 120, credit processing system 130, and a user device, in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

Point of sale device 120 and credit processing system 130 include communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 714 and cache memory 716. In general, memory 706 can include any suitable volatile or non-volatile computer-readable storage media.

Temporary passcode program 132 is stored in persistent storage 708 for execution by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in these examples, provides for communications with other data processing systems or devices, including resources of credit card transaction environment 100. In these examples, communications unit 710 includes one or more network interface cards. Communications unit 710 may provide communications through the use of either or both physical and wireless communications links. Temporary passcode program 132 may be downloaded to persistent storage 708 through communications unit 710.

I/O interface(s) 712 allows for input and output of data with other devices that may be connected to point of sale device 120 and credit processing system 130. For example, I/O interface 712 may provide a connection to external devices 718 such as a keyboard, keypad, a touch screen, and/or some other suitable input device. External devices 718 can also include portable computer-readable storage media such as, for example, thumb drives, portable optical or magnetic disks, and memory cards. Software and data used to practice embodiments of the present invention, e.g., temporary passcode program 132, can be stored on such portable computer-readable storage media and can be loaded onto persistent storage 708 via I/O interface(s) 712. I/O interface(s) 712 also connect to a display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for verifying the identity of a card user, the method comprising:
sending, by one or more computer processors, one or more temporary passcodes to a user device;
sending, by one or more computer processors, a prompt to a point of sale device, wherein the prompt requests a predefined, identifying input, and wherein the prompt is not ordinarily for the temporary passcode;
receiving, by one or more computer processors, the temporary passcode from a point of sale device; and
verifying, by one or more computer processors, that the received temporary passcode matches at least one of the one or more passcodes sent to the user device.

2. The method of claim 1, wherein the requested, predefined, identifying input is a zip code.

3. The method of claim 1, wherein the user device is a smart phone.

4. The method of claim 1, further comprising:
storing a plurality of temporary passcodes on the user device.

5. The method of claim 1, wherein the user device is a wirelessly enabled credit card having a display for displaying temporary passcodes.

6. The method of claim 1, wherein the user device comprises a biometric scanner for verifying a device user's biometric information.

7. A computer program product for verifying the identity of a card user, the computer program product comprising:
one or more computer-readable storage media;
program instructions stored on the one or more computer readable storage media which, when executed by the processor, performs the steps of:
sending, by one or more computer processors, one or more temporary passcodes to a user device;
sending, by one or more computer processors, a prompt to a point of sale device, wherein the prompt requests a predefined, identifying input, and wherein the prompt is not ordinarily for the temporary passcode from a point of sale device;
receiving, by one or more computer processors, the temporary passcode; and
verifying, by one or more computer processors, that the received temporary passcode matches at least one of the one or more passcodes sent to the user device.

8. The computer program product of claim 7, wherein the requested, predefined, identifying input is a zip code.

9. The computer program product of claim 7, wherein the user device is a smart phone.

10. The computer program product of claim 7, wherein the program instructions stored on the one or more computer readable storage media which, when executed by the processor, further perform the step of:
storing a plurality of temporary passcodes on the user device.

11. The computer program product of claim 7, wherein the user device is a wirelessly enabled credit card having a display for displaying temporary passcodes.

12. The computer program product of claim 7, wherein the user device comprises a biometric scanner for verifying a device user's biometric information.

13. The computer program product of claim 7, wherein the instructions were downloaded over a network from a remote data processing system.

14. The computer program product of claim 7, wherein the instructions are stored in a computer readable storage medium in a remote server data processing system, and wherein the instructions are downloaded over a network to a remote data processing system for use in a computer readable storage medium with the remote system.

15. A computer system for verifying the identity of a card user, the system comprising:
one or more computer processors;
one or more computer-readable storage media; and
program instructions stored on the one or more computer-readable storage media for execution by at least one of the one or more computer processors, which, when executed, perform:
sending, by one or more computer processors, one or more temporary passcodes to a user device;
sending, by one or more computer processors, a prompt to a point of sale device, wherein the prompt requests a predefined, identifying input, and wherein the prompt is not ordinarily for the temporary passcode;
receiving, by one or more computer processors, the temporary passcode from a point of sale device; and
verifying, by one or more computer processors, that the received temporary passcode matches at least one of the one or more passcodes sent to the user device.

16. The system of claim 15, wherein the requested, predefined, identifying input is a zip code.

17. The system of claim 15, wherein the user device is a smart phone.

18. The system of claim 15, further comprising:
storing a plurality of temporary passcodes on the user device.

19. The system of claim 15, wherein the user device is a wirelessly enabled credit card having a display for displaying temporary passcodes.

20. The system of claim 15, wherein the user device comprises a biometric scanner for verifying a device user's biometric information.
